(19) United States
(12) Patent Application Publication
(10) Pub. No.: US 2026/0187563 A1
(43) Pub. Date: Jul. 2, 2026

(54) SYSTEMS AND METHODS FOR GENERATING AN ABRASION INDEX

(71) Applicant: UnitedHealth Group Incorporated, Minnetonka, MN (US)

(72) Inventors: Amy L. Neftzger, Nashville, TN (US); Mark Robert Kanner, West Hartford, CT (US); Laura Stotts Gorans, Loomis, CA (US)

(21) Appl. No.: 19/005,883

(22) Filed: Dec. 30, 2024

(51) Int. Cl. G06Q 10/0637; G06Q 40/08

(52) U.S. Cl. CPC G06Q 10/0637; G06Q 40/08

(57) ABSTRACT

Techniques of the present disclosure relate to assessing the degree of abrasion (e.g., dissatisfaction, frustration, etc.) in a relationship between a service (e.g., healthcare) provider and a coverage provider (e.g., insurer and/or insurer health plan), in a manner that accounts for skewed data, determines outliers, and facilitates root cause analysis. The disclosed techniques generate an index using a combination of percentiles and other metrics (e.g., scores, ranks, etc.) to facilitate identifying and/or comparing service providers having the highest level of abrasion with a coverage provider. The index also facilitates an analysis of the root cause(s) and/or source(s) of abrasion by indicating the relevant classifications and associated feature subsets contributing to the abrasion.

### TECHNICAL FIELD

The present disclosure generally relates to abrasion between service providers and coverage providers, and more particularly, to techniques for assessing and indicating the degree of abrasion in such relationships.

### BACKGROUND

Assessing service provider (e.g., of healthcare services) abrasion (e.g., dissatisfaction, non-acceptability, etc.) with a coverage provider (e.g., of a healthcare plan/insurance) is generally prone to subjective interpretation and biases associated with the relevant data. Moreover, while abrasion assessments generally assume a linear relationship with service provider experiences, such relationships may have moderating factors, variables, and/or are otherwise include curvilinear relationships. Thus, when assuming a linear relationship, actual drivers of abrasion may be missed, or the importance of a specific key experience may be diluted. Moreover, the majority of provider experience data is in general not evenly distributed, causing measures of central tendency to be inaccurate and/or less meaningful when data is heavily skewed. Accordingly, existing techniques are often unable to accurately identify actionable operational drivers of satisfaction or dissatisfaction indicating service provider abrasion.

### BRIEF DESCRIPTION OF THE DRAWINGS

The figures described below depict embodiments for purposes of illustration only. One skilled in the art will readily recognize from the following discussion that alternative embodiments of the systems and methods illustrated herein may be employed without departing from the principles of the disclosure described herein. The detailed description is described with reference to the accompanying figures. In the figures, the same reference number appearing in different figures indicates a same or similar item.

FIG. 1 depicts an example computing environment in which various embodiments of the present disclosure can be implemented.

FIG. 2A depicts an example set of values and an example set of corresponding percentiles of a subfeature for a plurality of providers, in accordance with one embodiment and scenario.

FIG. 2B depicts an example set of subfeatures, an example set of percentiles, and a Euclidean distance equation, in accordance with one embodiment and scenario.

FIG. 2C depicts a first example set of percentiles, a second example set of percentiles, and a third example set of percentiles of a third classification abrasion metric, in accordance with one embodiment and scenario.

FIG. 2D depicts an example set of composite abrasion metrics, in accordance with one embodiment and scenario.

FIG. 3 depicts a flow diagram of an example method.

### DETAILED DESCRIPTION

Broadly speaking, the techniques of the present disclosure relate to assessing the degree of abrasion (e.g., dissatisfaction, frustration, etc.) in a relationship between a service (e.g., healthcare) provider and a coverage provider (e.g., insurer and/or insurer health plan), in a manner that accounts for skewed data, determines outliers, and facilitates root cause analysis.

The relationship between a service provider and a coverage provider (e.g., insurer/health plan) is a complex, one-to-many relationship, and has a broader range in the types of experiences, as compared to, for example, the relationship between customers/patients and healthcare providers. Moreover, most of the relevant measures across providers tend toward skewed distributions and violate the central limit theorem, which makes traditional outlier detection measures less accurate.

The disclosed techniques generate an index using a combination of percentiles and other metrics (e.g., scores, ranks, etc.) to facilitate identifying and/or comparing service providers having the highest level of abrasion with a coverage provider. The index also facilitates an analysis of the root cause(s) and/or source(s) of abrasion by indicating the relevant classifications and associated feature subsets contributing to the abrasion.

In particular, the disclosed use of percentiles can account for skewed data across different service providers, while reliably indicating negative outlier experiences. Moreover, the disclosed use of metrics that provide a multidimensional measure of the extent of the abrasion across features within a classification, and also across multiple classifications, provides a nested abrasion calculation/index that facilitates root cause analysis. Drilling into values of such an index facilitates identification of which features are out of an expected (or acceptable, etc.) range, which can simplify the root cause analysis. For example, the index may indicate that a service provider's claims are being delayed, denied, and later reconsidered at a high rate, are being appealed and overturned at a higher rate than other providers, and so on. The index may also, for example, indicate when a provider is frequently making multiple calls to a service recipient to resolve an issue. Such factors can allow a user to quickly identify causes of abrasion. The techniques can also be readily expanded to include additional and/or different features and/or categories.

The present disclosure includes specific features other than what is well-understood, routine, conventional activity in the field, or adding unconventional steps that demonstrate, in various embodiments, particular useful applications, e.g., obtaining values of a plurality of features for a first service provider with respect to a coverage provider; determining percentiles for the values including a first subset of percentiles of a first subset of features and a second subset of percentiles of a second subset of features; computing a first classification abrasion metric based at least in part on the first subset of percentiles; computing a second classification abrasion metric based at least in part on the second subset of percentiles; determining a percentile of the first classification abrasion metric relative to corresponding first classification abrasion metrics of the plurality of other service providers; determining a percentile of the second classification abrasion metric relative to corresponding second classification abrasion metrics of the plurality of other service providers; computing a composite abrasion metric of the first service provider based at least in part on the percentile of the first classification abrasion metric and the percentile of the second classification abrasion metric; and storing one or more data objects indicative of an index, the index including at least the first classification abrasion metric, the second classification abrasion metric, and the composite abrasion metric.

Of course, it should be appreciated that the advantages and technical improvements described above and elsewhere herein are not the only advantages and/or technical improvements that may be realized as a result of the techniques described herein. Other advantages and/or technical improvements to the functioning of a computer itself or other technologies or technical fields may be apparent to one of ordinary skill in the art. Moreover, while described herein primarily in the health care claims context, the techniques described herein may be readily applied in any suitable field for any suitable purpose.

### Example Computing Environment

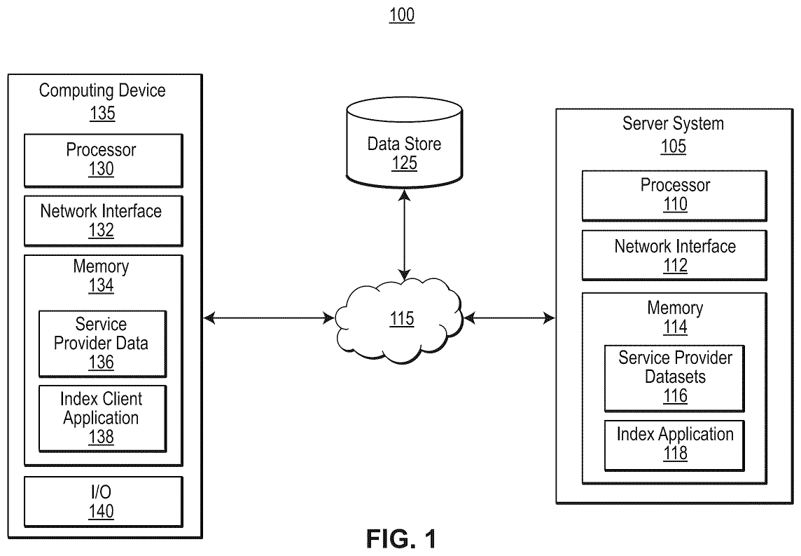

FIG. 1 depicts an example computing environment 100 in which various embodiments of the present disclosure may be implemented. Depending on the embodiment, the example computing environment 100 may compute classification abrasion metrics, determine percentiles, compute composite abrasion metrics, and/or otherwise perform operations associated with generating an index indicative of abrasion. Of course, it should be appreciated that, while the various components and/or devices of the computing environment 100 (e.g., a server system 105, a data store 125, a computing device 135) are illustrated in FIG. 1 as single components, the computing environment 100 may include multiple (e.g., dozens, hundreds, thousands) of each such device and/or other component.

Generally, the computing environment 100 includes the server system 105, a data store 125, and a computing device 135, at least some of which are communicatively coupled via a network 115. As an example, the server system 105 may be associated with an entity generating the index such as a coverage provider (e.g., an insurer and/or insurer health plan) and the computing device 135 may be associated with an entity providing and/or receiving data associated with the index such as a service provider (e.g., a healthcare provider) and/or the coverage provider (e.g., a health plan administrator). In such an example, one or more service providers may transmit or otherwise provide to the server system 105 (e.g., via respective computing devices 135) service provider data 136 associated with abrasion and/or other metrics of the index. The service provider data 136 may facilitate the coverage provider identifying and/or comparing service providers having the highest level of abrasion with the coverage provider.

The server system 105 may include only one server, or multiple servers that are co-located and/or remotely distributed. The server system 105 may be part of a cloud network (e.g., Amazon Web Services (AWS)®, Microsoft Azure®, or Google Cloud®) or may otherwise communicate with other hardware or software components within one or more cloud computing environments to send, retrieve, or otherwise analyze data or information described herein. In some example embodiments, the computing environment 100 comprises an on-premise computing environment, a multi-cloud computing environment, a public cloud computing environment, a private cloud computing environment, and/or a hybrid cloud computing environment.

The server system 105 includes at least one or more of a processor 110, a memory 114, and a network interface 112. The processor 110 may include any suitable number of processors and/or processor types. In some examples, the processor 110 include one or more central processing units (CPUs), one or more graphics processing units (GPUs), one or more tensor processing units (TPUs), one or more field-programmable gate arrays (FPGAs), one or more application-specific integrated circuits (ASICs), and/or the like. Generally, the processor 110 comprises hardware configured to execute instructions (e.g., processor-executable code/instructions) stored in a (e.g., the memory 114).

The network interface 112 may include one or more hardware and/or software components that are generally configured to enable the server system 105 to communicate, via the network 115, with other components and/or devices of the computing environment 100, such as the data store 125 and/or the computing device 135. To this end, the network interface 112 may include hardware and/or software that operates in accordance with at least one communication protocol of the network 115.

The memory 114 may include any suitable memory type(s), including one or more volatile memories (e.g., dynamic and/or static random-access memory (RAM)) and/or non-volatile memories (e.g., read-only memory (ROM), erasable programmable ROM (EPROM), electrically EROM (EEROM), NAND flash, and/or solid state drive(s) (SSD(s))), all or any of which are examples of non-transitory computer-readable media. In some examples, the memory 114 stores one or more of: an operating system, one or more software components (e.g., firmware, application(s), binary, source code, executable instructions, machine-learned model(s)), transient data and/or code loaded and/or operated on by one or more software component(s), and/or other suitable components/data. In one example, the memory 114 stores service provider datasets 116 (e.g. obtained from the data store 125, computing devices 135 of service providers) and processor-executable instructions of an index application 118.

The service provider datasets 116 may be associated with interactions between one or more service providers, coverage providers, and/or service recipients (e.g., healthcare patients of the service provider). The server system 105 (e.g., via the index application 118) may obtain at least a portion of the service provider datasets 116 from one or more data stores 125, computing devices 135, other servers 105, and/or other suitable sources of the service provider datasets 116. The service provider datasets 116 may include survey data (e.g., from service provider surveys), interaction data (e.g., from visits, calls, emails, text, messages, voicemails, communications, etc., between service providers, coverage providers, and/or service recipients), prior authorization data (e.g., indicating prior authorizations that are open, cancelled, closed, appealed, overturned), accounts receivable data (e.g., indicating insurance claims that are open, denied, closed, appealed, overturned, reconsidered), administrative burden data (e.g., indicating calls or other interactions between a service provider and service recipient), and/or other suitable types of data indicating interactions between service providers, coverage providers, and/or service recipients. It should be understood that, although FIG. 1 depicts the service provider datasets 116 as stored in the memory 114, the service provider datasets 116 may be stored in the data store 125 and/or other suitable storage accessible to the server system 105 and/or index application 118.

The index application 118, when executed (e.g., by the processor 110), may cause the server system 105 to perform operations associated with generating an index, such as obtaining values of a plurality of features of service providers, determining percentiles for the values, computing first and/or second classification abrasion metrics, determining percentiles associated with the first and/or second classification abrasion metrics, computing a composite abrasion metrics of service providers, generating and/or storing (e.g., in the memory 114, the data store 125) one or more data objects indicative of the index, and/or other suitable operations, as described herein. For example, the index application 118 may generate classifications and determine features by applying natural language processing, clustering, and/or other processing techniques to the service provider datasets 116, generate feature values or other abrasion metrics associated with the features using computations and/or formulas such as Euclidean distance, and so on.

The network 115 may include one or more wired and/or wireless communication networks, such as a cellular network (e.g., 5G®, 4G LTE®, 3G®), a Wi-Fi® network (i.e., an IEEE 802.11 standards network), a microwave access network (e.g., WiMAX®), and/or any other suitable wide area network (WAN), local area network (LAN), personal area network (PAN), etc. As just one example, the network 115 may include both a wireless LAN such as a Wi-Fi® network and a WAN such as the Internet. In some embodiments, the network 115 includes multiple, distinct and/or parallel networks (e.g., one or more networks facilitating communications between the server system 105 and the computing device 135, and one or more separate networks for facilitating communications between the server system 105 and the data store 125, etc.).

The data store 125 may be implemented as a database, data lake, memory, and/or other suitable digital storage. Accordingly, the data store 125 may be and/or include a file system data store, an object-based data store, and/or other type of data store utilized in the art. Depending on the embodiment, the data store 125 may be implemented locally at the server system 105, externally at an external data storage service, or a combination thereof. The server system 105, via the network interface 112, may be in wired or wireless communication with the external data storage service. The data store 125 may store data that obtained from one or more devices of the computing environment 100 (e.g., service provider data 136 received form the computing device 135), store data the server system 105 uses to perform one or more operations associated with generating the index (e.g., the service provider datasets 116 of one or more service providers), etc.

The computing device 135 may be, or include, one or more of a desktop computer, a laptop computer, a tablet device, a mobile device, a wearable device (e.g., augmented or virtual reality glasses/headsets), and/or any other suitable computing device. The computing device 135 may include at least one of a processor 130 (e.g., the processor 110), a memory 134 (e.g., the memory 114), a network interface 132 (e.g., the network interface 112), and/or an input/output (I/O) component 140. Although FIG. 1 depicts computing device 135 as a single device having multiple components, in some implementations the components of computing device 135 are instead divided among two or more communicatively coupled devices.

The I/O component 140 may include hardware and/or software that generally enables a user of the computing device 135 to interact with the computing device 135. The I/O component 140 may include one or more input components that enable a user of computing device 135 to provide input (e.g., a keyboard, a microphone, a mouse, a camera, etc.), one or more output components to generate outputs (e.g., a monitor/display, a speaker, a haptic feedback component, etc.), and/or one or more integrated I/O components (e.g., a touchscreen). The I/O component 140 may use any suitable technology or technologies, such as LED, OLED, or LCD display technology, for example.

The memory 134 may store service provide data 136. The service provider data 136 may be associated with a service provider associated with computing device 135, include the same or similar types of data as the service provider datasets 116, and/or comprise a portion of the service provider datasets 116.

The memory 134 may store an index client application 138. The index client application 138 may cause the computing device 135 to provide service provider data 136 (e.g., of a service provider associated with the computing device 135) to the server system 105 and/or data store 125 via the network 115, and/or may perform operations associated with the generating index (e.g., generate metrics and/or percentiles, display one or more data objects of the index via the I/O component 140), etc. The index client application 138 may be stored locally at the computing device 135 (e.g., in the memory 134), executed at the computing device 135 (e.g., via the processor 130), stored at a remote component and/or device (e.g., the data store 125, the server system 105), executed at a remote device (e.g., at the server system 105 via the processor 110), and/or any combination thereof.

It should be understood that the above disclosure is one example and does not necessarily describe every possible embodiment. As such, it will be further understood that alternate embodiments may include fewer, alternate, and/or additional components and/or devices.

### Example Workflow

In operation, the server system 105 may execute the index application 118 to generate or otherwise provide the index (e.g., one or more data objects indicative of the index). The server system 105 may execute the index application 118 according to schedule (e.g., continuously, intermittently), based upon a trigger (e.g., receipt of new service provider datasets 116 or a user request/command), at the request of a user (e.g., a user of the server system 105 executing index application 118, a user of the index client application 138), and/or in any other suitable manner. The index application 118 may cause the server system 105 to obtain values of a plurality of features for one or more service providers with respect to a coverage provider. In some embodiments, the index application 118 may generate the features, generate the feature values, classify the features, and/or perform other operations, based upon analyzing at least a portion of the service provider datasets 116. For example, the index application 118 may generate the index indicating abrasion of particular service providers of a region (e.g., North American service providers), and only use the portion of the service provider datasets 116 associated with the particular service providers. In another example, the index application 118 may analyze only a portion of the service provider datasets 116, such as the portions associated with a period of time (e.g., the most recent six months of service provider data), associated with provider having a threshold number of claims with the coverage provider, etc.

The plurality of features and/or feature values may include or otherwise indicate statistics associated with interactions between service providers and coverage providers (e.g., interactions associated with claims, prior authorization), and/or interactions between service providers and service recipients (e.g., visits, calls, emails, text, messages, voicemails), among other things, and/or as previously described. One or more feature classifications indicating or otherwise associated with abrasion may be associated with the plurality of features, such as a prior authorization classification, an accounts receivable classification, an administrative burden, and/or any other suitable classification. Additionally, each of one, some, or all of the feature classifications may be associated with a respective subset of the features, referred to at times herein as “subfeatures.” For example, the prior authorization classification may include subfeatures associated with the aforementioned prior authorization information (e.g., prior authorizations that are open, cancelled, closed, appealed, overturned), the accounts receivable classification may include subfeatures associated with the aforementioned accounts receivable information (e.g., insurance claims that are open, denied, closed, appealed, overturned, reconsidered), and/or the administrative burden classification may include subfeatures associated with the aforementioned administrative burden information (e.g., calls or other interactions between a service provider and service recipient).

The index application 118 may determine percentiles and/or other metrics for service providers using the features values, such as features values of the subfeatures associated with a single feature classification. The percentiles may indicate a ranking or other status of the service provider respective to other service providers (e.g., service providers associated with the same coverage provider) for the classification. For example, the index application 118 may determine a subset of percentiles of the closed prior authorizations subfeature associated with the prior authorization classification based upon the feature values of the closed prior authorizations subfeature of the prior authorization classification. In such an example, the subset of percentiles may be associated with twenty different service providers and indicate a ranking of the service providers respective to one another for the closed prior authorizations subfeature of the prior authorization classification.

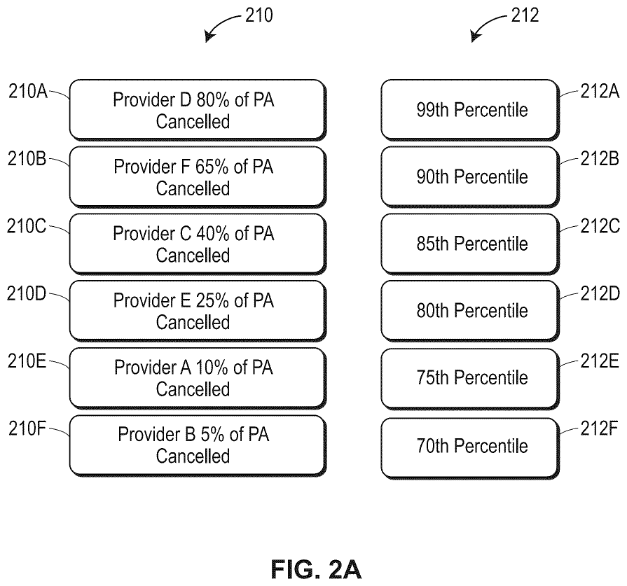

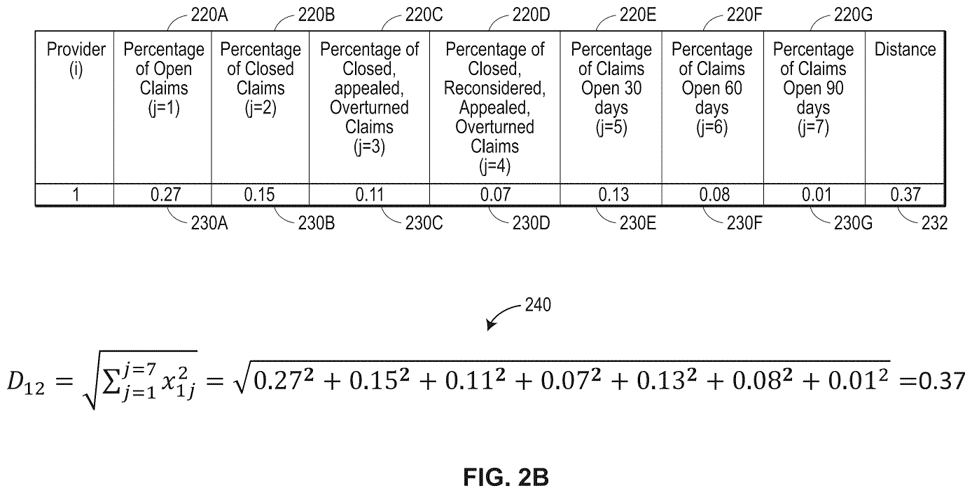

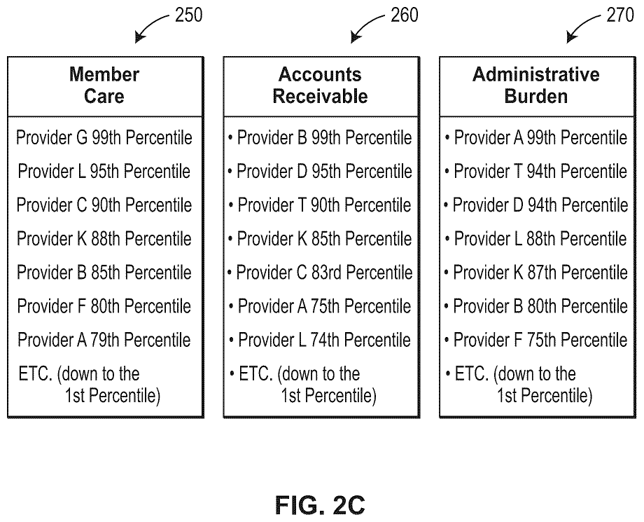

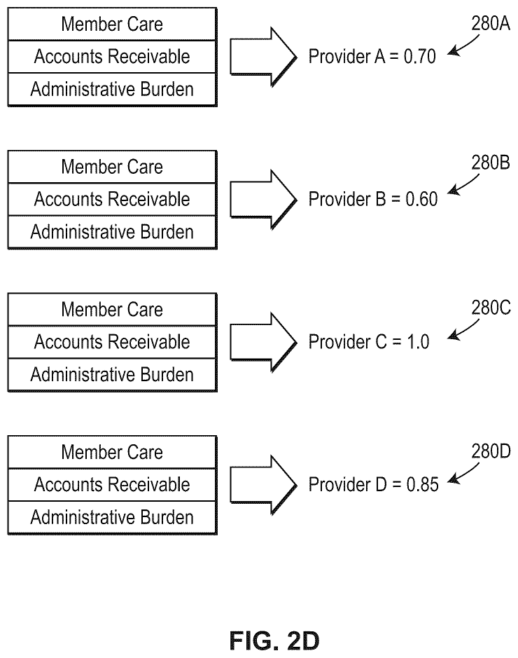

FIG. 2A depicts an example set of values 210A-210F and an example set of corresponding percentiles 212A-210F of a subfeature for a plurality of providers, in accordance with various embodiments described herein. More specifically, the example set of values 210A-210F may be associated with the subfeature of a percentage of prior authorizations cancelled of the prior authorization classification for six service different providers. In some embodiments, the index application 118 may determine the set of values 210A-210F (e.g., based upon raw data of the service provider datasets 116). FIG. 2A depicts values 210A-210F, each of one, some, or all of the respective values associated with a specific service provider, and each of one, some, or all of the respective values corresponding to a percentile 212A-212F. More specifically: (i) value 210A indicates Provider D has 80% of its prior authorizations cancelled, which corresponds to the 99th percentile of all cancelled prior authorizations; (ii) value 210B indicates Provider F has 65% of its prior authorizations cancelled, which corresponds to the 90th percentile of all cancelled prior authorizations; (iii) value 210C indicates Provider C has 40% of its prior authorization cancelled, which corresponds to the 85th percentile of cancelled prior authorizations; (iv) value 210D indicates Provider E has 25% of its prior authorization cancelled, which corresponds to the 80th percentile of all cancelled prior authorizations; (v) value 210E indicates Provider A has 10% of its prior authorization cancelled, which corresponds to the 75th percentile of all cancelled prior authorizations; and (vi) and value 210F indicates Provider B has 5% of its prior authorization cancelled, which corresponds to the 70th percentile of all cancelled prior authorizations. The index application 118 may determine similar percentiles of service providers for other subfeatures (e.g., percentage of prior authorizations open) associated with of the prior authorization classification, and/or subfeatures of other classifications (e.g., percentiles of open claims associated with the accounts receivable classification).

The index application 118 may compute an abrasion metric, referred to at times herein as a classification abrasion metric, of one or more of the classifications for one or more service providers. The abrasion metric of a service provider of a particular classification may be based at least in part on the subset of percentiles of the particular classification for the respective service provider. For example, the index application 118 may generate a first classification abrasion metric associated with the prior authorization classification based upon the subset of percentiles of subfeatures associated with the prior authorization classification, such as the subfeatures associated with prior authorizations that are open, prior authorizations that are cancelled, prior authorizations that are closed, prior authorizations that are appealed, and prior authorizations that are overturned. As another example, generating a second classification abrasion metric associated with the accounts receivable classification may be based upon the subset of percentiles of subfeatures associated with the accounts receivable classification, such as subfeatures assorted with claims that are open, claims that are denied, claims that are closed, claims that are appealed, claims that are overturned, and claims that are reconsidered. As yet another example, generating a third classification abrasion metric associated with the administrative burden classification based upon the subset of percentiles of subfeatures associated with the administrative burden classification, such as subfeatures associated with calls/interactions between a service provider and service recipient within a first period of time (e.g., 10 days) and calls/interactions between a service provider and service recipient within a second period of time (e.g., 30 days).

In some embodiments, computing a classification abrasion metric may include computing a Euclidean distance. In some embodiments, the classification abrasion metric may be, or include, one or more associated Euclidean distances. The Euclidean distance may be computed based at least in part on the subset of percentiles of a classification corresponding to the classification abrasion metric. For example, the index application 118 may generate the prior authorization classification abrasion metric of one or more service providers based on a percentile associated with prior authorizations that are open, a percentile associated with prior authorizations that are cancelled, a percentile associated with prior authorizations that are closed, a percentile associated with prior authorizations that are appealed, and a percentile associated with prior authorizations that are overturned. The index application 118 may compute Euclidean distances for each of one, some, or all of the respective classifications (e.g., using classification identifiers), for example computing a first Euclidean distance for the prior authorization classification, a second Euclidean distance for the accounts receivable classification, and a third Euclidean distance for the administrative burden classification. Thus, computing distinct Euclidean distances for each of one, some, or all of the of three respective classifications, as an example, can result in a set of three distinct Euclidean distances being associated with a service provider. The index application 118 may compute a set of Euclidean distances for one or more additional service providers (e.g., using service provider identifiers), such as all the service providers associated with coverage provider. The index application 118 may use the Euclidian distance for each of at least some of the multiple classifications, and for at least some of the multiple service providers, to generate useful information or data structures (e.g., a matrix having Euclidean distances of a single provider comprising respective rows of the matrix, and Euclidean distances for each classification comprising respective columns of the matrix), which may in turn facilitate root cause analysis of abrasion.

FIG. 2B depicts an example set of subfeatures 220, an example set of percentiles 230, and a Euclidean distance equation 240, in accordance with various embodiments described herein. More specifically, the example set of subfeatures 220 may be associated with a service provider and comprised of individual subfeatures 220A-220G associated with the accounts receivable classification, and the example set of percentiles 230 may be comprised of individual percentiles 230A-230G corresponding to respective individual subfeatures 220A-220G. The index application 118 may use the Euclidean distance equation 240 to compute the Euclidean distance (e.g., having a value of 0.37) of the accounts receivable classification for the service provider. The index application 118 may compute Euclidean distances for multiple classifications and/or multiple service providers using the disclosed techniques.

Computing the Euclidean distance may include using the formula:

$${D}_{i k} = {\{ \sqrt{{\sum }_{j} {x}_{ij}^{2}} \}}_{k}$$

wherein “Dᵢₖ” is the Euclidean distance for the i^{th} service provider and the j^{th} feature, “x” is a percentile of a feature of a classification, and “k” is an index of the classification. In the example of FIG. 2A, computing the first Euclidean distance for the accounts receivable classification (e.g., a first classification) results in a first Euclidean distance 232 having a value of 0.37. In some embodiments, one or more of the individual percentiles 230A-230G or first Euclidean distance may be normalized to a value, such as a value between zero and one. Similarly, the index application 118 may compute a second Euclidean distance for the prior authorization classification (e.g., a second classification) using percentiles of respective subfeatures of the prior authorization classification, and/or compute a third Euclidean distance for the administrative burden classification (e.g., a third classification) using percentiles of respective subfeatures of the administrative burden classification. The index application 118 use the disclosed techniques to compute sets of first, second, and/or third Euclidean distances for multiple service providers (e.g., associated with the same coverage provider).

The index application 118 may determine a percentile associated with a classification abrasion metric, such as percentiles of all respective classifications for all service providers. For example, the index application 118 may determine ten percentiles of ten respective service providers associated with a prior authorization classification abrasion metric, determine another ten percentiles of the same ten respective service providers associated with an accounts receivable classification abrasion metric, and yet another ten percentiles of the same ten respective service providers associated with an administrative burden classification abrasion metric.

Example percentiles of associated classification abrasion metrics are indicated by FIG. 2C, which depicts a first example set of percentiles 250 of a respective set of service providers of first a classification abrasion metric, a second example set of percentiles 260 of the respective set of service providers of a second classification abrasion metric, and a third example set of percentiles 270 of respective set of service providers of a third classification abrasion metric, in accordance with various embodiments described herein. More specifically, FIG. 2C depicts a first example set of percentiles 250 of a respective set of service providers of a member care classification abrasion metric (e.g., first classification abrasion metric), a second example set of percentiles 260 of the respective set of service providers of an accounts receivable classification abrasion metric (e.g., second classification abrasion metric), and a third example set of percentiles 270 of the respective set of service providers of an administrative burden classification abrasion metric (e.g., third classification abrasion metric). Determining percentiles for all service providers for each of one, some, or all of the classification abrasion metrics may provide equal weighting of all classification regardless of the total number of subfeatures of each of one, some, or all of the classifications, as the total number of subfeatures may vary from classification to classification.

In some embodiments, computing the percentile of an associated classification abrasion metric respective to one or more service providers may include computing values using the formula:

$${G}_{i k} = \frac{{D}_{i k}}{max {\{ {D}_{i} \}}_{k}}$$

wherein “Dᵢₖ” is the Euclidean distance associated with the classification associated with the classification abrasion metric for the i^{th} service provider and the k^{th} index of the classification, and “Gᵢₖ” is the percentile of a classification associated with the classification abrasion metric for the i^{th} service provider and the k^{th} index of the classification.

The index application 118 may compute a composite abrasion metric indicating abrasion of the service provider across all classifications. For example, the composite abrasion metric may be an aggregate metric for the member care classification (e.g., associated with prior authorizations), the accounts receivable classification, and the administrative burden classification of a service provider. Computing the composite abrasion metric may include computing a composite Euclidean distance based at least in part on the percentiles associated with classification abrasion metrics (e.g., the all percentiles of all the respective classification abrasion metrics). For example, composite abrasion metric of a service provider may include computing a composite Euclidean distance based on the percentile associated with the member care classification abrasion metric, the percentile associated with the account receivable classification abrasion metric, and the percentile associated with the administrative burden member care classification abrasion metric.

FIG. 2D depicts an example set of composite abrasion metrics 280A-280D for a respective set of service providers, in accordance with various embodiments described herein. Each of one, some, or all of the composite abrasion metrics 280A-280D is associated one of four respective service providers, and also associated with the member care classification, the accounts receivable classification, and the administrative burden classification of the respective service provider. The set of composite abrasion metrics 280A-280D indicates (i) provider A having an associated composite abrasion metric 280A of 0.7; (ii) provider B having an associated composite abrasion metric 280B of 0.6; (iii) provider C having an associated composite abrasion metric 280C of 1.0; and (iv) provider D having an associated composite abrasion metric 280D of 0.85. In some embodiments, the set of composite abrasion metrics 280A-280D may be normalized (e.g., to a value between one and ten).

In some embodiments, computing a composite abrasion metric (e.g., by the index application 118) may include computing a composite Euclidean distance. In some embodiments, the composite abrasion metric may be or include the composite Euclidean distance. Computing a composite Euclidean distance may include using the formula:

$${A}_{i} = \frac{1}{Q} \sqrt{{\sum }_{k} {G}_{ik}^{2}}$$

wherein “Aᵢ” is the composite abrasion metric for the i^{th} service provider, “Gᵢₖ” is a percentile of a classification associated with the classification abrasion metric for the i^{th} service provider and the k^{th} index of the classification, and “Q” is a total number of classifications.

The index application 118 may store one or more data objects indicative of an index (e.g., an abrasion index). The index, and/or data objects, may include and/or otherwise indicate one or more metrics or otherwise values the index application 118 determines and/or computes, such as the first classification abrasion metric, the second classification abrasion metric, Euclidean distances, the composite abrasion metric, and/or the composite Euclidean distance.

It will be understood that the above disclosure is one example and does not necessarily describe every possible embodiment. As such, it will be further understood that alternate embodiments may include fewer, alternate, and/or additional steps or elements.

### Example Method

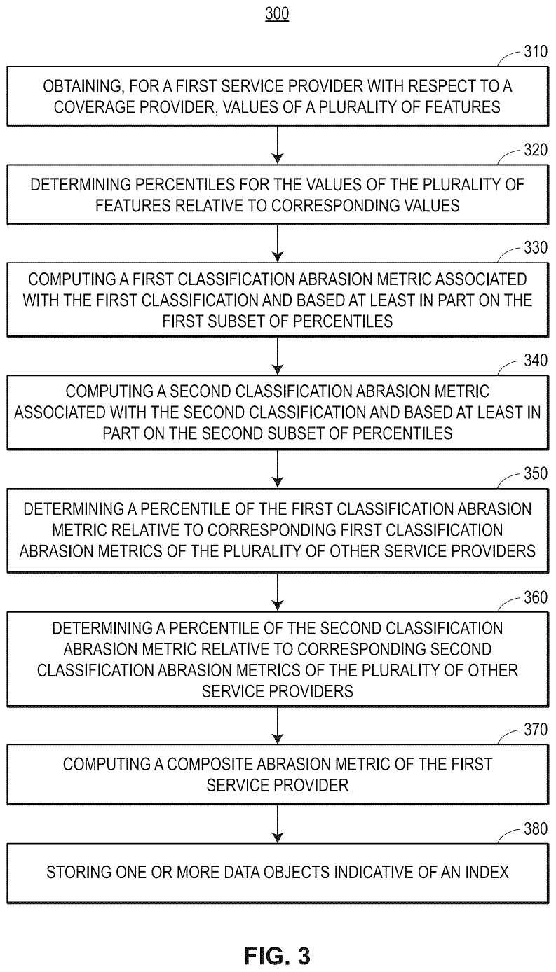

FIG. 3 depicts a flow diagram representing an example method 300, in accordance with various embodiments described herein. The method 300 may be implemented by server system 105 when processor 110 executes instructions stored in memory 114.

The method 300 may include obtaining, for a first service provider with respect to a coverage provider, values of a plurality of features (block 310). The plurality of features may be, include, and/or indicate statistics associated with interactions between service providers and coverage providers. The plurality of features may include at least a first subset of features associated with a first classification and a second subset of features associated with a second classification. The values of the plurality of features may be obtained from survey data and/or call data. The values of the plurality of features may be associated with a particular period of time (e.g., the last 6 months).

The first subset of features of the first classification may include one or more of a number of open prior authorizations, a percentage of prior authorizations cancelled, a percentage of prior authorizations closed, a percentage of prior authorizations closed with appeal then overturned, or a percentage of prior authorizations closed in a particular number of days. The second subset of features of the second classification include one or more of percentage of open insurance claims; percentage of insurance claims closed with denial; percentage of insurance claims closed with appeal and overturned; percentage of insurance claims closed with reconsideration and appeal and then overturned; percentage of insurance claims open over a particular number of days. The values of the plurality of features may include statistics associated with interactions between service providers and service recipients.

The method 300 may include determining percentiles for the values of the plurality of features relative to corresponding values (block 320), of the plurality of features, for a plurality of other service providers with respect to the coverage provider. The percentiles for the values may include a first subset of percentiles associated with the first subset of features and a second subset of percentiles associated with the second subset of features.

The method 300 may include computing a first classification abrasion metric associated with the first classification and based at least in part on the first subset of percentiles (block 330). In some embodiments, computing the first classification abrasion metric (block 330) may include computing a first Euclidean distance based at least in part on the first subset of percentiles.

The method 300 may include computing a second classification abrasion metric associated with the second classification based at least in part on the second subset of percentiles (block 340). In some embodiments, computing the second classification abrasion metric (block 340) may include computing a second Euclidean distance based at least in part on the second subset of percentiles.

In some embodiments of the method 300, computing the first Euclidean distance or the second Euclidean distance includes using the formula:

$${D}_{i k} = {\{ \sqrt{{\sum }_{j} {x}_{ij}^{2}} \}}_{k}$$

wherein “Dᵢₖ” is the Euclidean distance for the i^{th} service provider and the j^{th} feature, “x” is a percentile of a feature of a classification, and “k” is an index of the classification.

The method 300 may include determining a percentile of the first classification abrasion metric relative to corresponding first classification abrasion metrics of the plurality of other service providers (block 350).

The method 300 may include determining a percentile of the second classification abrasion metric relative to corresponding second classification abrasion metrics of the plurality of other service providers (block 360).

The method 300 may include computing a composite abrasion metric of the first service provider (block 370) based at least in part on the percentile of the first classification abrasion metric and the percentile of the second classification abrasion metric. Computing the composite abrasion metric (block 370) may include computing a composite Euclidean distance using the formula:

$${A}_{i} = \frac{1}{Q} \sqrt{{\sum }_{k} {G}_{ik}^{2}}$$

wherein “Aᵢ” is the composite abrasion metric for the i^{th} service provider, “Gᵢₖ” is a percentile of a classification associated with the classification abrasion metric for the i^{th} service provider and the k^{th} index of the classification, and “Q” is a total number of classifications.

The method 300 may include storing one or more data objects indicative of an index (block 380). The index may include at least the first classification abrasion metric, the second classification abrasion metric, and the composite abrasion metric. In some embodiments, one or more of the first classification abrasion metric, classification abrasion metric, or composite abrasion metric may be a normalized value (e.g., between zero and one, between zero and ten, etc.)

In some embodiments of the method 300, the values of the plurality of features may include at least a third subset of features associated with a third classification. The third subset of features may include one or more repeat contacts between the service provider and service recipient within a particular number of days (e.g., 5 days from a previous interaction, 90 days from the previous interaction, etc.). In some such embodiments, the method 300 may include one or more of determining the third subset of percentiles associated with a third subset of features, computing a third classification abrasion metric associated with the third classification based at least in part on the third subset of percentiles, determining a percentile of the third classification abrasion metric of a service provider relative to corresponding third classification abrasion metrics of the plurality of other service providers, computing a composite abrasion metric of the service provider further based at least in part on the percentile of the third classification abrasion metric, and/or storing one or more data objects indicative of an index including at least the third classification abrasion metric.

In some embodiments, the method 300 may include determining the service provider submits a threshold number of claims to the coverage providers based upon analyzing service provider data.

### EXAMPLES

Example 1. A method comprising: obtaining, by one or more processors, and for a first service provider with respect to a coverage provider, values of a plurality of features, the plurality of features (i) being statistics associated with interactions between service providers and coverage providers, and (ii) including at least a first subset of features associated with a first classification and a second subset of features associated with a second classification; determining, by the one or more processors, percentiles for the values of the plurality of features relative to corresponding values, of the plurality of features, for a plurality of other service providers with respect to the coverage provider, the percentiles for the values including a first subset of percentiles associated with the first subset of features and a second subset of percentiles associated with the second subset of features; computing, by the one or more processors, a first classification abrasion metric associated with the first classification and based at least in part on the first subset of percentiles; computing, by the one or more processors, a second classification abrasion metric associated with the second classification based at least in part on the second subset of percentiles; determining, by the one or more processors, a percentile of the first classification abrasion metric relative to corresponding first classification abrasion metrics of the plurality of other service providers; determining, by the one or more processors, a percentile of the second classification abrasion metric relative to corresponding second classification abrasion metrics of the plurality of other service providers; computing, by the one or more processors, a composite abrasion metric of the first service provider based at least in part on the percentile of the first classification abrasion metric and the percentile of the second classification abrasion metric; and storing, by the one or more processors, one or more data objects indicative of an index, the index including at least the first classification abrasion metric, the second classification abrasion metric, and the composite abrasion metric.

Example 2. The method of Example 1 wherein computing the first classification abrasion metric includes computing a first Euclidean distance based at least in part on the first subset of percentiles; and computing the second classification abrasion metric includes computing a second Euclidean distance based at least in part on the second subset of percentiles.

Example 3. The method of Example 2 wherein computing the first Euclidean distance or the second Euclidean distance includes using a formula:

$${D}_{i k} = {\{ \sqrt{{\sum }_{j} {x}_{ij}^{2}} \}}_{k} ,$$

wherein: “Dᵢₖ” is a Euclidean distance for an i^{th} service provider and a k^{th} index of the classification; “x” is a percentile of a feature of the classification; and “k” is an index of the classification.

Example 4. The method of Example 3 wherein computing the composite abrasion metric includes computing a composite Euclidean distance using the formula:

$${A}_{i} = \frac{1}{Q} \sqrt{{\sum }_{k} {G}_{ik}^{2}} ,$$

wherein: “Aᵢ” is a composite abrasion metric for the i^{th} service provider; “Gᵢₖ” is a percentile of a classification associated with a classification abrasion metric for the i^{th} service provider and the k^{th} index of the classification; and “Q” is a total number of classifications.

Example 5. The method of any one of Examples 1 to 4 further comprising: determining, by the one or more processors, a service provider submits a threshold number of claims to the coverage providers based upon analyzing service provider data.

Example 6. The method of any one of Examples 1 to 5 wherein the first subset of features of the first classification include one or more of a number of open prior authorizations, a percentage of prior authorizations cancelled, a percentage of prior authorizations closed, a percentage of prior authorizations closed with appeal then overturned, or a percentage of prior authorizations closed in a particular number of days.

Example 7. The method of any one of Examples 1 to 6 wherein the second subset of features of the second classification include one or more of percentage of open insurance claims; percentage of insurance claims closed with denial; percentage of insurance claims closed with appeal and overturned; percentage of insurance claims closed with reconsideration and appeal and then overturned; percentage of insurance claims open over a particular number of days.

Example 8. The method of any one of Examples 1 to 7 wherein the values of the plurality of features include (i) statistics associated with interactions between service providers and service recipients, and (ii) at least a third subset of features associated with a third classification.

Example 9. The method of Example 8 wherein the third subset of features of the third classification include one or more repeat contacts between a service provider and a service recipient within a particular number of days.

Example 10. The method of any one of Examples 1 to 9 wherein the values of the plurality of features are obtained from survey data and/or call data.

Example 11. The method of any one of Examples 1 to 10 wherein the values of the plurality of features are associated with a particular period of time.

Example 12. The method of any one of Examples 1 to 11 wherein one or more of the first classification abrasion metric, classification abrasion metric, or composite abrasion metric is a normalized value.

Example 13. A system to perform operations comprising the method of any one of claims 1-12.

Example 14. One or more non-transitory computer-readable media storing processor-executable instructions that, when executed by one or more processors, cause the one or more processors to perform operations comprising the method of any one of claims 1-12.

### CONCLUSION

Throughout this specification, components, operations, or structures described as a single instance may be implemented as multiple instances. Although individual operations of one or more methods (or processes, techniques, routines, etc.) are illustrated and described as separate operations, two or more of the individual operations may be performed concurrently or otherwise in parallel, and nothing requires that the operations be performed in the order illustrated. Structures and functionality (e.g., operations, steps, blocks) presented as separate components in example configurations may be implemented as a combined structure, functionality, or component. Similarly, structures and functionality presented as a single component may be implemented as separate components. These and other variations, modifications, additions, and improvements fall within the scope of the subject matter herein.

Certain embodiments are described herein as including logic or a number of routines, subroutines, applications, operations, blocks, or instructions. These may constitute and/or be implemented by software (e.g., code embodied on a non-transitory, machine-readable medium), hardware, or a combination thereof. In hardware, the routines, etc., may represent tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware component that operates to perform certain operations as described herein.

In various embodiments, a hardware component may be implemented mechanically or electronically. For example, a hardware component may comprise dedicated circuitry or logic that is permanently configured (e.g., as a special-purpose processor, such as a field programmable gate array (FPGA) or an application-specific integrated circuit (ASIC)) to perform certain operations. A hardware component may also or instead comprise programmable logic or circuitry (e.g., as encompassed within one or more general-purpose processors and/or other programmable processor(s)) that is temporarily configured by software to perform certain operations.

Accordingly, the term “hardware component” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware components are temporarily configured (e.g., programmed), each of the hardware components need not be configured or instantiated at any one instance in time. For example, where the hardware components include a general-purpose processor configured using software, the general-purpose processor may be configured as respective different hardware components at different times. Software may accordingly configure a processor, for example, to constitute a particular hardware component at one instance of time and to constitute a different hardware component at a different instance of time.

Hardware components can provide information to, and receive information from, other hardware components. Accordingly, the described hardware components may be regarded as being communicatively coupled. Where multiple of such hardware components exist contemporaneously, communications may be achieved through signal transmission (e.g., over appropriate circuits and buses) that connect the hardware components. In embodiments in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information).

As noted above, the various operations of example methods (or processes, techniques, routines, etc.) described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions. The components referred to herein may, in some example embodiments, comprise processor-implemented components.

Moreover, each operation of processes illustrated as logical flow graphs may represent a sequence of operations that can be implemented in hardware, software, or a combination thereof. In the context of software, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

The terms “coupled” and “connected,” along with their derivatives, may be used. In particular embodiments, “connected” may be used to indicate that two or more elements are in direct physical or electrical contact with each other, although the context in the description may dictate otherwise when it is apparent that two or more elements are not in direct physical or electrical contact. “Coupled” may mean that two or more elements are in direct physical or electrical contact. However, “coupled” may also mean that two or more elements are not in direct contact with each other, yet still co-operate, transmit between, or interact with each other.

An algorithm may be considered to be a self-consistent sequence of acts or operations leading to a desired result. These include physical manipulations of physical quantities. Usually, though not necessarily, these quantities take the form of electrical, magnetic, or optical signals capable of being stored, transferred, combined, compared, and otherwise manipulated. These signals are commonly referred to as bits, values, elements, symbols, characters, terms, numbers, flags, or the like. It should be understood, however, that all of these and similar terms are to be associated with the appropriate physical quantities and are merely convenient labels applied to these quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “some embodiments,” “one embodiment,” “an embodiment,” “in some examples,” or variations thereof means that a particular element, feature, structure, characteristic, operation, or the like described in connection with the embodiment is included in at least one embodiment, but not every embodiment necessarily includes the particular element, feature, structure, characteristic, operation, or the like. Different instances of such a reference in various places in the specification do not necessarily all refer to the same embodiment, although they may in some cases. Moreover, different instances of such a reference may describe elements, features, structures, characteristics, operations, or the like be combined in any manner as an embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless the context of use clearly indicates otherwise, “or” refers to an inclusive or and not to an exclusive or. For example, a condition A or B is satisfied by any one of the following: A is true (or present) and B is false (or not present), A is false (or not present) and B is true (or present), and both A and B are true (or present).

The term “set” is intended to mean a collection of elements and can be a null set (i.e., a set containing zero elements) or may comprise one, two, or more elements. A “subset” is intended to mean a collection of elements that are all elements of a set, but that does not include other elements of the set. A first subset of a set may comprise zero, one, or more elements that are also elements of a second subset of the set. The first subset may be said to be a subset of the second subset if all the elements of the first subset are elements of the second subset, while also being a subset of the set. However, if all the elements of the second subset are also elements of the first subset (in addition to all the elements of the first subset being elements of the second subset), the first subset and the second subset are a single subset/not distinct.

For the purposes of the present disclosure, the term “a” or “an” entity refers to one or more of that entity. As such, the terms “a” or “an”, “one or more”, and “at least one” can be used interchangeably herein unless explicitly contradicted by the specification using the word “only one” or similar. For example, “a first element” may functionally be interpreted as “a first one or more elements” or a “first at least one element.” Unless otherwise apparent from the context of use, reference in the present disclosure to a same set of “one or more processors” (or a same “plurality of processors,” etc.) performing multiple operations can encompass implementations in which performance of the operations is divided among the processor(s) in any suitable way. For example, “generating, by one or more processors, X; and generating, by the one or more processors, Y” can encompass: (1) implementations in which a first subset of the processors (e.g., in a first computing device) generates X and an entirely distinct, second subset of the processors (e.g., in a different, second computing device) independently generates Y; (2) implementations in which one or more or all of the processor(s) (e.g., one or multiple processors in the same device, or multiple processors distributed among multiple devices) contribute to the generation of X and/or Y; and (3) other variations. This may similarly be applied to any other component or feature similarly recited (e.g., as “a component”, “a feature”, “one or more components”, “one or more features”, “a plurality of components”, “a plurality of features”). Moreover, the performance of certain of the operations may be distributed among the one or more components, not only residing within a single machine, but deployed across a number of machines. The set of components may be located in a single geographic location (e.g., within a home environment, an office environment, a cloud environment). In other example embodiments, the set of components may be distributed across two or more geographic locations. Further, “a machine-learned model”, equivalent terms (e.g., “machine learning model,” “machine-learning model,” “machine-learned component”, “artificial intelligence”, “artificial intelligence component”), or species thereof (e.g., “a large language model”, “a neural network”) may include a single machine-learned model or multiple machine-learned models, such as a pipeline comprising two or more machine-learned models arranged in series and/or parallel, an agentic framework of machine-learned models, or the like.

Moreover, any discussion of receiving data associated with an individual that may be protected, confidential, or otherwise sensitive information, is understood to have been preceded by transmitting a notice of use of the data to a computing device, account, or other identifier (collectively, “identifier”) associated with the individual, receiving an indication of authorization to use the data from the identifier, and/or providing a mechanism by which a user may cause use of the data to cease or a copy of the data to be provided to the user.

Upon reading this disclosure, those of skill in the art will appreciate still additional alternative structural and functional designs through the principles disclosed herein. Therefore, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

The patent claims at the end of this patent application are not intended to be construed under 35 U.S.C. § 114 (f) unless traditional means-plus-function language is expressly recited, such as “means for” or “step for” language being explicitly recited in the claim(s).

What is claimed is:

1. A method comprising:
obtaining, by one or more processors, and for a first service provider with respect to a coverage provider, values of a plurality of features, the plurality of features (i) being statistics associated with interactions between service providers and coverage providers, and (ii) including at least a first subset of features associated with a first classification and a second subset of features associated with a second classification;
determining, by the one or more processors, percentiles for the values of the plurality of features relative to corresponding values, of the plurality of features, for a plurality of other service providers with respect to the coverage provider, the percentiles for the values including a first subset of percentiles associated with the first subset of features and a second subset of percentiles associated with the second subset of features;
computing, by the one or more processors, a first classification abrasion metric associated with the first classification and based at least in part on the first subset of percentiles;
computing, by the one or more processors, a second classification abrasion metric associated with the second classification based at least in part on the second subset of percentiles;
determining, by the one or more processors, a percentile of the first classification abrasion metric relative to corresponding first classification abrasion metrics of the plurality of other service providers;
determining, by the one or more processors, a percentile of the second classification abrasion metric relative to corresponding second classification abrasion metrics of the plurality of other service providers;
computing, by the one or more processors, a composite abrasion metric of the first service provider based at least in part on the percentile of the first classification abrasion metric and the percentile of the second classification abrasion metric; and
storing, by the one or more processors, one or more data objects indicative of an index, the index including at least the first classification abrasion metric, the second classification abrasion metric, and the composite abrasion metric.

2. The method of claim 1, wherein:
computing the first classification abrasion metric includes computing a first Euclidean distance based at least in part on the first subset of percentiles; and
computing the second classification abrasion metric includes computing a second Euclidean distance based at least in part on the second subset of percentiles.

3. The method of claim 2, wherein computing the first Euclidean distance or the second Euclidean distance includes using a formula:
$${D}_{i k} = {\{ \sqrt{{\sum }_{j} {x}_{ij}^{2}} \}}_{k} ,$$
wherein:
Dᵢₖ is a Euclidean distance for an i^{th} service provider and a k^{th} index of the classification;
x is a percentile of a feature of the classification; and
k is an index of the classification.

4. The method of claim 3, wherein computing the composite abrasion metric includes computing a composite Euclidean distance using the formula:
$${A}_{i} = \frac{1}{Q} \sqrt{{\sum }_{k} {G}_{ik}^{2}} ,$$
wherein:
Aᵢ is a composite abrasion metric for the i^{th} service provider;
Gᵢₖ is a percentile of a classification associated with a classification abrasion metric for the i^{th} service provider and the k^{th} index of the classification; and
Q is a total number of classifications.

5. The method of claim 1, further comprising:
determining, by the one or more processors, a service provider submits a threshold number of claims to the coverage providers based upon analyzing service provider data.

6. The method of claim 1, wherein the first subset of features of the first classification include one or more of a number of open prior authorizations, a percentage of prior authorizations cancelled, a percentage of prior authorizations closed, a percentage of prior authorizations closed with appeal then overturned, or a percentage of prior authorizations closed in a particular number of days.

7. The method of claim 1, wherein the second subset of features of the second classification include one or more of percentage of open insurance claims; percentage of insurance claims closed with denial; percentage of insurance claims closed with appeal and overturned; percentage of insurance claims closed with reconsideration and appeal and then overturned; percentage of insurance claims open over a particular number of days.

8. The method of claim 1, wherein the values of the plurality of features include (i) statistics associated with interactions between service providers and service recipients, and (ii) at least a third subset of features associated with a third classification.

9. The method of claim 8, wherein the third subset of features of the third classification include one or more repeat contacts between a service provider and a service recipient within a particular number of days.

10. The method of claim 1, wherein the values of the plurality of features are obtained from survey data and/or call data.

11. The method of claim 1, wherein the values of the plurality of features are associated with a particular period of time.

12. The method of claim 1, wherein one or more of the first classification abrasion metric, classification abrasion metric, or composite abrasion metric is a normalized value.

13. A system comprising:
one or more processors; and
at least one memory storing processor-executable instructions that, when executed by the one or more processors, cause the one or more processors to perform operations comprising:
obtain and for a first service provider with respect to a coverage provider, values of a plurality of features, the plurality of features (i) being statistics associated with interactions between service providers and coverage providers, and (ii) including at least a first subset of features associated with a first classification and a second subset of features associated with a second classification,
determine percentiles for the values of the plurality of features relative to corresponding values, of the plurality of features, for a plurality of other service providers with respect to the coverage provider, the percentiles for the values including a first subset of percentiles associated with the first subset of features and a second subset of percentiles associated with the second subset of features,
compute a first classification abrasion metric associated with the first classification and based at least in part on the first subset of percentiles, compute a second classification abrasion metric associated with the second classification based at least in part on the second subset of percentiles,
determine a percentile of the first classification abrasion metric relative to corresponding first classification abrasion metrics of the plurality of other service providers,
determine a percentile of the second classification abrasion metric relative to corresponding second classification abrasion metrics of the plurality of other service providers,
compute a composite abrasion metric of the first service provider based at least in part on the percentile of the first classification abrasion metric and the percentile of the second classification abrasion metric, and
store one or more data objects indicative of an index, the index including at least the first classification abrasion metric, the second classification abrasion metric, and the composite abrasion metric.

14. The system of claim 13, wherein:
to compute the first classification abrasion metric includes computing a first Euclidean distance based at least in part on the first subset of percentiles; and
to compute the second classification abrasion metric includes computing a second Euclidean distance based at least in part on the second subset of percentiles.

15. The system of claim 14, wherein computing the composite abrasion metric includes computing a composite Euclidean distance.

16. The system of claim 13, wherein the first subset of features of the first classification include one or more of a number of open prior authorizations, a percentage of prior authorizations cancelled, a percentage of prior authorizations closed, a percentage of prior authorizations closed with appeal then overturned, or a percentage of prior authorizations closed in a particular number of days.

17. The system of claim 13, wherein the second subset of features of the second classification include one or more of percentage of open insurance claims; percentage of insurance claims closed with denial; percentage of insurance claims closed with appeal and overturned; percentage of insurance claims closed with reconsideration and appeal and then overturned; percentage of insurance claims open over a particular number of days.

18. The system of claim 13, wherein the values of the plurality of features include (i) statistics associated with interactions between service providers and service recipients, and (ii) at least a third subset of features associated with a third classification.

19. The system of claim 13, wherein one or more of the first classification abrasion metric, classification abrasion metric, or composite abrasion metric is a normalized value.

20. One or more non-transitory computer-readable media storing processor-executable instructions that, when executed by one or more processors, cause the one or more processors to perform operations comprising:
obtaining and for a first service provider with respect to a coverage provider, values of a plurality of features, the plurality of features (i) being statistics associated with interactions between service providers and coverage providers, and (ii) including at least a first subset of features associated with a first classification and a second subset of features associated with a second classification;
determining percentiles for the values of the plurality of features relative to corresponding values, of the plurality of features, for a plurality of other service providers with respect to the coverage provider, the percentiles for the values including a first subset of percentiles associated with the first subset of features and a second subset of percentiles associated with the second subset of features;
computing a first classification abrasion metric associated with the first classification and based at least in part on the first subset of percentiles;
computing a second classification abrasion metric associated with the second classification based at least in part on the second subset of percentiles;
determining a percentile of the first classification abrasion metric relative to corresponding first classification abrasion metrics of the plurality of other service providers;
determining a percentile of the second classification abrasion metric relative to corresponding second classification abrasion metrics of the plurality of other service providers;
computing a composite abrasion metric of the first service provider based at least in part on the percentile of the first classification abrasion metric and the percentile of the second classification abrasion metric; and
storing one or more data objects indicative of an index, the index including at least the first classification abrasion metric, the second classification abrasion metric, and the composite abrasion metric.
